(19) United States
(12) Patent Application Publication
(10) Pub. No.: US 2023/0358702 A1
(43) Pub. Date: Nov. 9, 2023

(54) METHOD FOR PREPARING NADH AND ETHANOL BIOSENSING CHIP

(71) Applicant: NANJING TECH UNIVERSITY, Nanjing, Jiangsu Province (CN)

(72) Inventors: Zhenyu CHU, Nanjing, Jiangsu Province (CN); Sijian ZHANG, Nanjing, Jiangsu Province (CN); Wanqin JIN, Nanjing, Jiangsu Province (CN)

(73) Assignee: NANJING TECH UNIVERSITY, Nanjing, Jiangsu Province (CN)

(21) Appl. No.: 18/044,994

(22) PCT Filed: Oct. 15, 2020
(86) PCT No.: PCT/CN2020/121110

§ 371 Date: Mar. 13, 2023

(30) Foreign Application Priority Data
Sep. 17, 2020 (CN) 202010979555.0

(51) Int. Cl. G01N 27/327

(52) U.S. Cl. CPC G01N 27/3277; G01N 27/3278

(57) ABSTRACT

The invention relates to a simple method for preparing an NADH and ethanol biosensing chip, applicable to NADH or ethanol detection in the fermentation field, clinical medicine and food engineering. The sensing material described in the present invention is simple in preparation and can be prepared in batches, the nanogold is uniformly distributed on the surface of nickel hexacyanoferrate, and the quality of the sensing chip prepared based on this material is controllable. The sensing chip uses ethanol dehydrogenase as a biorecognition element and is more selective. The sensor chip detects ethanol and NADH in a wide linear range without dilution at a single detection time of less than 30 s and can realize real-time monitoring of fermentation broth.

### TECHNICAL FIELD

The present invention relates to a simple method for preparing an ethanol biosenser, applicable to NADH or ethanol detection in the fermentation field, clinical medicine and food engineering.

### BACKGROUND ART

In recent years, with the rapid development of economy, the concept of sustainability, energy, environment and other issues are getting more prominent. Promoting the use of fuel ethanol is an important strategic initiative to alleviate energy and environmental problems. Fuel ethanol as the most successful biomass alternative in the world has formed a new energy industry in the United States, Brazil, the European Union and other countries and regions. China started the fuel ethanol industry during the “Tenth Five-Year Plan” period. After more than a decade, China has grown into the third largest producer and user of biofuel ethanol in the world, following the United States and Brazil. As the most important source of ethanol, ethanol fermentation has received a lot of attention. In the process of ethanol fermentation, the concentration of ethanol is one of the main parameters of fermentation, which on the one hand influences the growth of yeast and on the other hand influences the catalytic performance of various enzymes involved in the fermentation process. Generally, the fermentation process will cease when the concentration of ethanol reaches 14%. Therefore, the detection of ethanol concentration is particularly important in the field of fermentation. The conventional ethanol detection methods include spectrophotometry, chromatography and colorimetry. These methods usually require pre-treatment, take a longtime in detection and get results later, so they are unable to provide real-time concentration values.

Electrochemical sensors have gained much attention due to the advantages of easy operation, low cost, stable performance and high accuracy. The core of electrochemical sensors lies in the sensing electrodes, including the development of high-performance sensing materials and the preparation of sensing chips. No research results have been reported in the literature on the use of biosensors for real-time detection of ethanol and NADH, and there is still a research gap in the technology for online real-time monitoring of ethanol and NADH.

### SUMMARY OF THE INVENTION

An objective of the present invention is to prepare an ethanol biosenser, which is used for accurate detection of ethanol concentration during fermentation. The preparation process of the biosensor is simple and has a low cost and a good application value. The technical solution of the present invention: A biosenser, with the following preparation steps:
1) Preparation and synthesis of synthetic solutions A and B of nickel hexacyanoferrate, including the following:

Synthetic solution A is an anionic acid solution. Synthetic solution B is a cationic acid solution. In order to form uniform cubic particles, the two synthetic solutions shall have the same pH value and ion concentration. Synthetic solutions A and B are dropwise added simultaneously to a beaker at the same addition rate by micro syringe pump. After the addition, it is stirred for a certain time. Then a certain amount of solution B is dropwise added at the same addition rate again. After the addition, the synthetic solution is centrifugally cleaned several times and then transferred to a beaker. Deionized water is added to obtain a nickel hexacyanoferrate suspension.
2) Synthesis of gold nanoparticles/nickel hexacyanoferrate/carbon mixed ink, including the following:

A chloroauric acid solution is dropwise added to the nickel hexacyanoferrate suspension by micro syringe pump. After the addition, a reducing solution is dropwise added to the suspension. After the addition, centrifugal cleaning and drying are conducted to obtain gold nanoparticles/nickel hexacyanoferrate mixed powder. The gold nanoparticles/nickel hexacyanoferrate mixed powder is evenly mixed with carbon ink at a certain mass ratio to obtain gold nanoparticles/nickel hexacyanoferrate/carbon mixed ink.
3) Printing of a biosensing chip, including the following:

The gold nanoparticles/nickel hexacyanoferrate/carbon mixed ink is fixed on a support by the screen-printing technique to form a working electrode. An ethanol dehydrogenase mixed solution containing a certain amount of glutaraldehyde is prepared. A certain amount of the mixed enzyme solution is taken and evenly applied on the working electrode. The working electrode is dried at low temperature in a refrigerator to obtain a biosensing chip for ethanol detection.

Preferably, in step 1, the ion concentrations of synthetic solution A and synthetic solution B are both in the range of 0.001-0.1M, and the pH values are both in the range of 1-6; the temperature of crystallization reaction is 10-60° C.; the injection rates of synthetic solution A and synthetic solution B are both in the range of 100-1,00001 min.

Preferably, in step 1, the anion donor is one of K₃[Fe(CN)₆] and K₄[Fe(CN)₆], and the cation donor is one of NiCl₂, NiSO₄ and Ni(NO₃)₂; the acid solution is one of hydrochloric acid, sulfuric acid and nitric acid.

Preferably, in step 1, the stirring time is 10 min-1 h, and the volume of added solution B is 30-90 ml.

Preferably, in step 1, the centrifugal rate is 5,000 r/min-10,000 r/min, the centrifugal time is 3 min-15 min, the centrifugal times are 2 to 5 times, and the volume of deionized water is 10-100 mL.

Preferably, in step 2, the reducing solution is one of sodium citrate, ascorbic acid and glucose.

Preferably, in step 2, the molar ratio of chloroauric acid to the reducing substance in the reducing solution is 1:5-1:15.

Preferably, in step 2, the mass ratio of gold nanoparticles/nickel hexacyanoferrate powder to carbon ink is 1:5-1:20; in step 3, the support is one of PVC, PET and alumina.

Preferably, in step 3, the concentration of ethanol dehydrogenase solution is 0.1-1 U/μL, the volume percent of glutaraldehyde in the mixed enzyme solution is 0.5%-2%, the volume of the mixed enzyme solution applied on the working electrode is 1-5 μl, and the ethanol biosensing chip is dried at 0-10° C.

The present invention provides an ethanol and/or NADH detection method. The biosensing chip prepared by the foregoing method is used for the detection.

The present invention provides an application of the biosensing chip obtained by the foregoing preparation method in ethanol and/or NADH detection.

The detection of ethanol by electrochemical method is mainly based on the catalytic oxidation of NADH by electrode materials at a certain voltage and the generation of an electric current, which reflects the content of ethanol. Nickel hexacyanoferrate has good catalytic performance and can effectively catalyze the oxidation of NADH. The present patent uses nickel hexacyanoferrate as a sensing material and introduces gold nanoparticles to improve the electrical conductivity of the material. By controlling the nanostructure of the material, gold nanoparticles/nickel hexacyanoferrate, a nanocomposite material with high catalytic selectivity for NADH, is obtained, and an ethanol biosenser is prepared in combination with the screen-printing technique. Thanks to the excellent electrocatalytic properties, stability and biocompatibility of the material, the prepared biosenser has a broader detection range than existing sensors do and enables dilution-free detection of ethanol in fermentation broth.

### Advantages of the Present Invention

1. The sensing material described in the present invention is simple in preparation and can be prepared in batches, the nanogold is uniformly distributed on the surface of nickel hexacyanoferrate, and the quality of the sensing chip prepared based on this material is controllable.
2. The sensing chip uses ethanol dehydrogenase as a biorecognition element and is more selective.
3. The sensor chip detects ethanol and NADH in a wide linear range without dilution at a single detection time of less than 30 s and can realize real-time monitoring of fermentation broth.

### BRIEF DESCRIPTION OF THE DRAWINGS

FIG. 1 is an electron micrograph of gold nanoparticles/nickel hexacyanoferrate obtained in Embodiment 1.

### DETAILED DESCRIPTION

The present invention will be further described below with reference to embodiments from which the foregoing objectives, features and advantages of the present invention will be more evident. It should be noted that if without conflict, the embodiments of the present invention and the features in the embodiments can be combined.

The description below illustrates many details to fully understand the present invention, but the present invention can also be implemented in other ways different from this description, so the present invention is not limited to the embodiments disclosed below.

Below the technical solution of the present invention is described in detail.

### Embodiment 1

An ethanol biosensing chip, with the following preparation process:
1) Prepare 0.001MK₃[Fe(CN)₆] and 0.001MNiCl₂·6H₂O solutions, and adjust the pH values of the solutions by hydrochloric acid (HCl) to 6 to obtain HCl solutions. Synthesize a nickel hexacyanoferrate precursor solution by the micro-speed chemical synthesis method: Take the two HCl solutions, each 90 ml, fix them in a syringe pump and set the synthesis temperature at 10° C. and the injection rate at 100 μL/min. The low injection rate adopted in this embodiment can reduce the crystallization rate of crystal and obtain more regular particles. Stir for 15 min after the injection, and then dropwise add 90 mL of the NiCl₂·6H₂O HCl solution at a rate of 100 μL/min. Centrifuge the mixed solution at 5,000 r/min for 10 min after the addition. Then conduct centrifugal cleaning using deionized water twice. It is okay that the deionized water submerges the solid, while its volume can be changed, which has no impact on the product. The centrifugal rate is 5,000 r/min and the centrifugal time is 15 min each time. After the centrifugal cleaning, re-disperse the obtained solid into 100 mL of deionized water to obtain a nickel hexacyanoferrate suspension.
2) Prepare a 2 mM HAuCl₄ solution and a 10 mM sodium citrate solution, measure 20 mL of the HAuCl₄ solution, fix it in a syringe pump, dropwise add it to the nickel hexacyanoferrate suspension obtained in step 1) at an injection rate of 100 μL/min, measure 20 mL of the sodium citrate solution after the addition, fix it in the syringe pump and dropwise add it at an injection rate of 100 μL/min, and continue to stir for 30 min after the addition. Centrifuge the foregoing mixed solution at 5,000 r/min for 15 min, conduct centrifugal cleaning using deionized water at 5,000 r/min for 15 min twice, pour out the liquid after the cleaning and dry the solid at 30° C. for 8 h to obtain gold nanoparticles/nickel hexacyanoferrate. Weigh 0.1 g of gold nanoparticles/nickel hexacyanoferrate and mix it with 0.5 g of conductive carbon paste to obtain a mixed paste.
3) Prepare a biosensing chip by the screen-printing technique. Prepare a 0.1 U/μL ethanol dehydrogenase solution, containing 0.5% v/v glutaraldehyde. Measure 5 μL of the solution, place it on the working electrode of the chip and dry it at 0° C. to obtain an ethanol biosensing chip. In this embodiment, drying at 0° C. will not damage enzyme activity.

The sensing chip detects ethanol by the following steps: Connect the contacts of the reference electrode, counter electrode and working electrode of the sensing chip to an electrochemical workstation, do a timed amperometric current test on ethanol in a phosphate buffer solution (PBS) with a pH value of 7.0 and containing 0.1 mM coenzyme NAD⁺, and draw a working curve of ethanol concentration and response current.

The calculation shows that the ethanol detection sensitivity of the biosensing chip obtained in this embodiment is 1.69 μA·mM⁻¹·cm⁻², and the detection limit is as low as 0.01 mM. After the test, the modified electrode was kept in a pH 7.0 PBS at 0° C. for one week and its response signal was 94% of the initial signal; after a month, its response signal was 86% of the initial signal, suggesting that this chip has very good stability.

### Embodiment 2

An ethanol biosensing chip, with the following preparation process:
1) Prepare 0.01M K₄[Fe(CN)₆] and 0.01M NiSO₄ solutions, and adjust the pH values of the solutions by sulfuric acid to 4. Synthesize a nickel hexacyanoferrate precursor solution by the micro-speed chemical synthesis method: Take the two acid solutions, each 90 ml, fix them in a syringe pump and set the synthesis temperature at 20° C. and the injection rate at 200 μL/min. Stir for 20 min after the injection, and then dropwise add 70 mL of NiSO₄ sulfuric acid solution at a rate of 200 μL/min. Centrifuge the mixed solution at 6,000 r/min for 10 min after the addition. Then conduct centrifugal cleaning using deionized water at 6,000 r/min for 10 min three times, and re-disperse the obtained solid into 70 mL of deionized water to obtain a nickel hexacyanoferrate suspension.
2) Prepare a 2 mM HAuCl₄ solution and a 10 mM sodium citrate solution, measure 20 mL of the HAuCl₄ solution, fix it in a syringe pump, dropwise add it to the solution obtained in step 1) at an injection rate of 200 μL/min, measure 25 mL of the sodium citrate solution after the addition, fix it in the syringe pump and dropwise add it at an injection rate of 200 μL/min, and continue to stir for 30 min after the addition. Centrifuge the foregoing mixed solution at 6,000 r/min for 20 min, then conduct centrifugal cleaning using deionized water at 6,000 r/min for 10 min three times, pour out the liquid after the cleaning and dry the solid at 30° C. for 8 h to obtain gold nanoparticles/nickel hexacyanoferrate. Weigh 0.1 g of gold nanoparticles/nickel hexacyanoferrate and mix it with 0.8 g of conductive carbon paste to obtain a mixed paste.
3) Prepare a biosensing chip by the screen-printing technique. Prepare a 0.3 U/μL ethanol dehydrogenase solution, containing 1.0% v/v glutaraldehyde. Measure 5 μL of the solution, place it on the working electrode of the chip and dry it at 0° C. to obtain an ethanol biosensing chip.

The detection method is the same as that in Embodiment 1.

The calculation shows that the ethanol detection sensitivity of the biosensing chip obtained in this embodiment is 1.89 μA·mM⁻¹·cm⁻², and the detection limit is as low as 0.01 mM. After the test, the modified electrode was kept in a pH7.0 PBS at 0° C. for one week and its response signal was 89% of the initial signal; after a month, its response signal was 82% of the initial signal, suggesting that this chip has very good stability.

### Embodiment 3

An ethanol biosensing chip, with the following preparation process:
1) Prepare 0.05MK₄[Fe(CN)₆] and 0.05MNi(NO₃)₂ solutions, and adjust the pH values of the solutions by nitric acid to 3. Synthesize a nickel hexacyanoferrate precursor solution by the micro-speed chemical synthesis method: Take the two solutions, each 90 ml, fix them in a syringe pump and set the synthesis temperature at 40° C. and the injection rate at 500 μL/min. Stir for 40 min after the injection, and then dropwise add 50 mL of Ni(NO₃)₂ nitric acid solution at a rate of 500 μL/min. Centrifuge the mixed solution at 8,000 r/min for 6 min after the addition. Then conduct centrifugal cleaning using deionized water at 6,000 r/min for 6 min four times, take out the solid, and re-disperse the obtained solid into 50 mL of deionized water to obtain a nickel hexacyanoferrate suspension.
2) Prepare a 2 mM HAuCl₄ solution and a 10 mM glucose solution, measure 20 mL of the HAuCl₄ solution, fix it in a syringe pump, dropwise add it to the solution obtained in step 1) at an injection rate of 100 μL/min, measure 30 mL of the glucose solution after the addition, fix it in the syringe pump and dropwise add it at an injection rate of 500 μL/min, and continue to stir for 30 min after the addition. Centrifuge the foregoing mixed solution at 8,000 r/min for 6 min, then conduct centrifugal cleaning using deionized water at 8,000 r/min for 6 min four times, pour out the liquid after the cleaning and dry the solid at 30° C. for 8 h to obtain gold nanoparticles/nickel hexacyanoferrate. Weigh 0.1 g of gold nanoparticles/nickel hexacyanoferrate and mix it with 1.2 g of conductive carbon paste to obtain a mixed paste.
3) Prepare a biosensing chip by the screen-printing technique. Prepare a 0.5 U/μL ethanol dehydrogenase solution, containing 1.5% v/v glutaraldehyde. Measure 5 μL of the solution, place it on the working electrode of the chip and dry it at 0° C. to obtain an ethanol biosensing chip.

The detection method is the same as that in Embodiment 1.

The calculation shows that the ethanol detection sensitivity of the biosensing chip obtained in this embodiment is 2.06 μA·mM⁻¹·cm⁻², and the detection limit is as low as 0.01 mM. After the test, the modified electrode was kept in a pH7.0 PBS at 0° C. for one week and its response signal was 88% of the initial signal; after a month, its response signal was 83% of the initial signal, suggesting that this chip has very good stability.

### Embodiment 4

An ethanol biosensing chip, with the following preparation process:
1) Prepare 0.1MK₄[Fe(CN)₆] and 0.1MNi(NO₃)₂ solutions, and adjust the pH values of the solutions by nitric acid to 1. Synthesize a nickel hexacyanoferrate precursor solution by the micro-speed chemical synthesis method: Take the two solutions, each 90 ml, fix them in a syringe pump and set the synthesis temperature at 60° C. and the injection rate at 1,000 μL/min. Stir for 20 min after the injection, and then dropwise add 30 mL of Ni(NO₃)₂ nitric acid solution at a rate of 1,000 μL/min. Centrifuge the mixed solution at 10,000 r/min for 3 min. Then conduct centrifugal cleaning using deionized water at 10,000 r/min for 3 min five times, and re-disperse the obtained solid into 50 mL of deionized water to obtain a nickel hexacyanoferrate suspension.
2) Prepare a 2 mM HAuCl₄ solution and a 10 mM ascorbic acid solution, measure 20 mL of the HAuCl₄ solution, fix it in a syringe pump, dropwise add it to the solution obtained in step 1) at an injection rate of 1,000 μL/min, measure 30 mL of the ascorbic acid solution after the addition, fix it in the syringe pump and dropwise add it at an injection rate of 1,000 μL/min, and continue to stir for 30 min after the addition. Centrifuge the foregoing mixed solution at 10,000 r/min for 3 min, then conduct centrifugal cleaning using deionized water at 10,000 r/min for 3 min five times, pour out the liquid after the cleaning and dry the solid at 30° C. for 8 h to obtain gold nanoparticles/nickel hexacyanoferrate. Weigh 0.1 g of gold nanoparticles/nickel hexacyanoferrate and mix it with 2 g of conductive carbon paste to obtain a mixed paste.
3) Prepare a biosensing chip by the screen-printing technique. Prepare a 1 U/μL ethanol dehydrogenase solution, containing 2.0% v/v glutaraldehyde. Measure 4 μL of the solution, place it on the working electrode of the chip and dry it at 0° C. to obtain an ethanol biosensing chip.

The calculation shows that the ethanol detection sensitivity of the biosensing chip obtained in this embodiment is 1.36 μA·mM⁻¹·cm⁻², and the detection limit is as low as 0.01 mM. After the test, the modified electrode was kept in a pH7.0 PBS at 0° C. for one week and its response signal was 86% of the initial signal; after a month, its response signal was 79% of the initial signal, suggesting that this chip has very good stability.

The following method is used to detect the concentration of ethanol in fermentation broth by the ethanol biosensing chips prepared in Embodiments 1 to 4:

Based on the foregoing examples, the four kinds of ethanol biosensing chips prepared are used to detect the concentration of ethanol in fermentation broth by the timed amperometric current method. Firstly, ethanol with a known concentration is used as a standard sample. The content of ethanol in the fermentation broth is calculated by calculating the ratio of the current responded by ethanol to the current responded by the fermentation broth. The results are as shown in Table 1:

TABLE 1
Results of biosensing chip performance test

| | Concentration | | |
|---|---|---|---|
| | of ethanol in | Tested ethanol | Relative |
| | fermentation | concentration | standard |
| Biosensingchip | broth (mM) | (mM) | deviation |
| 1 | 0.11 | 0.116 | 5.45% |
| 2 | 0.11 | 0.119 | 8.18% |
| 3 | 0.11 | 0.114 | 3.63% |
| 4 | 0.11 | 0.121 | 9.09% |

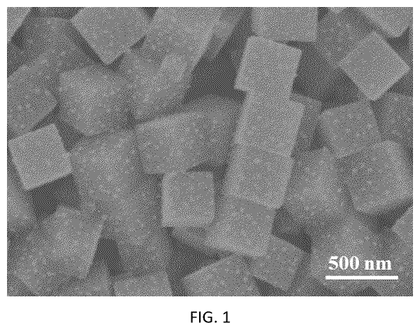

As shown in Table 1, the obtained ethanol biosensing chips can be used to detect the concentration of ethanol in fermentation broth effectively. The gold nanoparticles/nickel hexacyanoferrate obtained in Embodiment 1 was shot under an electron microscope. The results are as shown in FIG. 1. The prepared gold nanoparticles/nickel hexacyanoferrate has an obvious cubic contour. Further, gold nanoparticles are uniformly distributed on every crystal surface of the nickel hexacyanoferrate nano cubes.

### Embodiment 5

This embodiment provides an application case for NADH detection by biosensing chip.
The sensing chip obtained in Embodiment 1 is used for the detection.
The application method comprises the following steps:
Connecting the contacts of the reference electrode, counter electrode and working electrode of the sensing chip to an electrochemical workstation, doing a timed amperometric current test on ethanol in a phosphate buffer solution (PBS) with a pH value of 7.0, and drawing a working curve of NADH concentration and response current.
The calculation shows that the NADH detection sensitivity of the biosensing chip obtained in this embodiment is 96.86 μA·mM⁻¹·cm⁻², and the detection limit is as low as 0.05 mM. After the test, the modified electrode was kept in a pH7.0 PBS at 0° C. for one week and its response signal was 96% of the initial signal; after a month, its response signal was 91% of the initial signal, proving that this chip has very excellent long-term stability.

1. A method for preparing an NADH and ethanol biosensing chip, wherein the method comprises the following preparation steps:
step 1: preparation of synthetic solution A and synthetic solution Band synthesis of nickel hexacyanoferrate
synthetic solution A is an anionic acid solution, synthetic solution B is a cationic acid solution, and the two synthetic solutions have the same pH value and ion concentration; synthetic solutions A and B are dropwise added at the same rate, and are stirred after the addition; and then synthetic solution B is dropwise added at the same rate, and the solution is centrifuged and cleaned several times and then transferred to deionized water to obtain a nickel hexacyanoferrate suspension;
step 2: synthesis of gold nanoparticles/nickel hexacyanoferrate/carbon mixed ink
a chloroauric acid solution is dropwise added to the nickel hexacyanoferrate suspension, a reducing solution is dropwise added after the addition, and centrifugal cleaning and drying are conducted after the addition to obtain gold nanoparticles/nickel hexacyanoferrate mixed powder; carbon ink is added to the powder and mixed evenly to obtain gold nanoparticles/nickel hexacyanoferrate/carbon mixed ink; and
step 3: preparation of a biosensing chip
the gold nanoparticles/nickel hexacyanoferrate/carbon mixed ink obtained in step 2 is fixed on a support by the screen-printing technique to form a working electrode; glutaraldehyde is added to an ethanol dehydrogenase solution to obtain a mixed enzyme solution; the mixed enzyme solution is evenly applied on the working electrode, and the working electrode is dried at low temperature to obtain a biosensing chip.

2. The method for preparing a biosensing chip according to claim 1, wherein in step 1, the ion concentrations of synthetic solution A and synthetic solution B are both in the range of 0.001-0.1M, and the pH values being both in the range of 1-6; the temperature of crystallization reaction being 10-60° C. the injection rates of synthetic solution A and synthetic solution B being both in the range of 100-1,000 μL/min.

3. The method for preparing a biosensing chip according to claim 1, wherein in step 1, the anion donor is one of K₃[Fe(CN)₆] and K₄[Fe(CN)₆], and the cation donor being one of NiCl₂, NiSO₄ and Ni(NO₃)₂; the acid solution being one of hydrochloric acid, sulfuric acid and nitric acid.

4. The method for preparing a biosensing chip according to claim 1, wherein in step 1, the centrifugal rate is 5,000 r/min-10,000 r/min, the centrifugal time being 3 min-30 min, the centrifugal times being 2 to 5 times, and the volume of deionized water being 10-100 mL.

5. The method for preparing a biosensing chip according to claim 1, wherein in step 2, the reducing solution is one of sodium citrate, ascorbic acid and glucose.

6. The method for preparing a biosensing chip according to claim 1, wherein in step 2, the molar ratio of chloroauric acid to the reducing substance in the reducing solutions 1:3-1:9.

7. The method for preparing a biosensing chip according to claim 1, wherein in step 2, the mass ratio of gold nanoparticles/nickel hexacyanoferrate powder to carbon ink is 1:5-1:20; in step 3, the support being one of PVC, PET and alumina.

8. The method for preparing a biosensing chip according to claim 1, wherein in step 3, the concentration of ethanol dehydrogenase solutions 0.1-1 U/μL, the volume percent of glutaraldehyde in the mixed enzyme solution being 0.5%-2%, the volume of the mixed enzyme solution applied on the working electrode being 1-5 μl, and the ethanol biosensing chip being dried at 0-10° C.

9. An ethanol and/or NADH detection method, wherein the biosensing chip prepared by the method in claim 1 is used for the detection.

10. An application of the biosensing chip obtained by the preparation method in claim 1 in ethanol and/or NADH detection.
